(19) United States
(12) Patent Application Publication
(10) Pub. No.: US 2026/0251524 A1
(43) Pub. Date: Aug. 27, 2026

(54) GAS AND GAS-LEAK DETECTION SYSTEM AND METHODS THEREFOR

(71) Applicant: California Institute of Technology, Pasadena, CA (US)

(72) Inventors: Axel SCHERER, Barnard, VT (US); Taeyoon JEON, Pasadena, CA (US); Changsoon CHOI, Pasadena, CA (US)

(21) Appl. No.: 19/545,688

(22) Filed: Feb. 20, 2026

Related U.S. Application Data
(60) Provisional application No. 63/762,797, filed on Feb. 25, 2025.

(51) Int. Cl. G01M 3/38; G01M 3/40

(52) U.S. Cl. CPC G01M 3/38; G01M 3/40

(57) ABSTRACT

A gas-leak detection system includes a narrow-wavelength tunable laser, a beam scanner, a detector, a plurality of retroreflectors, and signal-processing electronics. The laser, beam scanner, and detector are co-located, and the plural retroreflectors are distributed throughout a facility. The laser is tuned so that its optical frequency is near to a frequency of an absorption line of a gas of interest, and modulated to create a controlled scan across the frequency of the absorption line. The beam scanner guides the laser beam towards some or all of the retroflectors, depending on the system’s operating mode. The retroreflectors return respective beams to the detector, where the respective intensities thereof are detected. The intensity of a return beam correlates to gas concentration. Since gas-concentration data is obtained at multiple locations, a gas leak and its location may be determined.

### STATEMENT OF RELATED CASES

This disclosure pertains to gas/gas-leak detection, and more particularly, to gas detection employing narrow-bandwidth tunable lasers.

### BACKGROUND

Tunable Diode Laser Absorption Spectroscopy (TDLAS) measures gas concentration by detecting intensity drops when target gas molecules are present in the optical path between a narrow-linewidth tunable laser and a detector. More particularly, gas molecules, such as methane, carbon dioxide, water, ammonia, etc., absorb light at very specific wavelengths corresponding to their rotational-vibrational transitions. The TDLAS technique detects and quantifies a gas species based on the absorption of laser light at those specific wavelengths. The amount of absorbed light enables direct calculation of gas concentration.

Gas-detection systems based on TDLAS techniques have been used in the oil and gas industry to detect gas-leaks. There are, however, drawbacks to the use of such systems, as implemented in the past.

### SUMMARY

Embodiments of the invention provide systems and methods for gas-leak detection based on TDLAS techniques, but which avoid certain limitations of existing TDLAS-based leak-detection systems.

In accordance with the illustrative embodiment, a gas/gas-leak detection system includes at least one narrow-wavelength tunable laser, at least one beam scanner, at least one detector, a plurality of retroreflectors, and signal-processing electronics. The laser, beam scanner, and detector are co-located, and the plural retroreflectors are distributed throughout a facility (e.g., installed on or near surfaces within a gas facility, or otherwise in the vicinity of equipment, pipelines, etc., through which gas flows).

Before gas-monitoring operations can begin, the system must be commissioned. Commissioning requires placing the retroreflectors throughout a region to be monitored. And in preferred embodiments, commissioning requires a calibration step that provides the system with data required to precisely direct laser light to each retroreflector.

As to placement, the retroreflectors must be placed in locations that provide line-of-sight to the anticipated placement location of the laser/beam scanner/detector. Beyond line-of-sight considerations, at least some of the retroreflectors are placed at locations at which leaks are relatively more likely to occur, which may vary as a function of the type of facility in which the system is to be installed.

The calibration step obtains the information required for the beam scanner to direct laser light to each of the retroreflectors. The specifics of the information required is a function of the type of beam scanner being employed. For example, in embodiments in which the beam scanner is a galvanometer, the system must possess the information required to precisely orient the galvanometer’s mirror to direct the laser light to each one of the plural retroreflectors. That information may be a voltage, etc., required to rotate the mirror to a desired angle/orientation. The calibration data, once obtained, may be stored in a look-up table, etc.

After the commissioning steps are completed, regular gas-monitoring operations can begin. During such regular operation, laser is tuned so that its optical frequency is near to the frequency of the absorption line of a gas of interest. The laser is modulated to create a controlled scan across the absorption line, which enables extraction of absorption information with high sensitivity.

The beam scanner directs the laser beam, towards some or all of the retroflectors (one at a time), depending on the system’s operating mode. Each retroreflector that receives a beam returns it to the detector, where the intensity of the returned beam is detected. If molecules of the gas of interest are present in the path between the laser and a retroreflector, the intensity of the reflected beam will be affected thereby (reducing its intensity relative to the outgoing beam). Because absorption is nonlinear with respect to wavelength near a spectral line, the detected signal contains harmonics of the modulation frequency. Of particular interest is the second harmonic (2f), which is processed to determine the concentration of the gas. Since gas-concentration data is obtained at multiple locations, a gas leak and its location may be determined.

In some embodiments, the invention provides a system for identifying a gas leak and estimating a location thereof in a monitored area, wherein the system includes:

a narrow-wavelength tunable laser for producing a beam of light, wherein the laser is tuned so that its optical frequency is near to a frequency of an absorption line of a gas of interest, and modulated to create a controlled scan across the frequency of the absorption line;

a plurality of retroreflectors, wherein the retroreflectors are sited at various locations throughout the monitored area;

a beam scanner, wherein there is line-of-sight between the beam scanner and the plurality of retroreflectors so that the retroreflectors receive the beam of light from the laser;

a photodetector for receiving respective return beams from the retroflectors, and generating respective signals indicative of an intensity of the return beams; and

signal-processing electronics for estimating a location of a gas leak based on the signals.

In some embodiments, the invention provides a method for identifying a gas leak and estimating a location thereof in a monitored area, wherein the method includes:

directing a beam of light from a first, narrow-wavelength tunable laser to plural retroreflectors, the retroreflectors being sited at various locations throughout the monitored area, wherein the beam of light has an optical frequency near to a frequency of an absorption line of a gas of interest, and the beam of light is modulated to create a controlled scan across the frequency of the absorption line;

receiving, at a first photodetector, respective beams of light returned from the plural retroreflectors;

generating, at the first photodetector, signals that are indicative of an intensity of the beams of light returned from respective plural retroreflectors;

determining, for each of the plural retroreflectors, a respective concentration of the gas of interest based on the intensity of beams of light returned from respective retroreflectors; and

estimating a first location of a gas leak based on the determined concentrations and locations in the monitored area of the plural retroreflectors.

Additional embodiments in accordance with the present teachings are provided in the drawings and detailed description that follows.

### BRIEF DESCRIPTION OF THE DRAWINGS

FIG. 1 depicts a flow diagram of conventional TDLAS processing for gas detection.

FIG. 2A depicts a gas leak-detection system in accordance with an illustrative embodiment of the invention.

FIG. 2B depicts the operation of a retroreflector in the system of FIG. 2A.

FIG. 3 depicts a method in accordance with the present invention.

FIG. 4 depicts a method for identifying the location of retroreflectors, in accordance with the present teachings.

FIG. 5A depicts a sequential scanning method for measuring gas concentration via the system of FIG. 2A.

FIG. 5B depicts a histogram showing gas-concentration measurement data obtained from the scanning method of FIG. 5A.

FIG. 6 depicts an adaptive scanning method for measuring gas concentration via the system of FIG. 2A.

FIG. 7 depicts an alternative embodiment of a gas leak-detection system incorporating plural lasers/beam scanners/detectors.

### DETAILED DESCRIPTION

The following disclosure merely illustrates the principles of the invention. It will thus be appreciated that in light of the disclosure, those skilled in the art will be able to devise various arrangements which, although not explicitly described or shown herein, embody the principles of the invention and are included within its spirit and scope. Furthermore, all examples and conditional language recited herein are principally intended for pedagogical purposes to aid the reader in understanding the principles of the invention and the concepts contributed by the inventor(s) to furthering the art, and are to be construed as being without limitation to specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as those developed in the future; that is, any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes that may be substantially represented in computer readable medium and so executed by a computer or processor, whether or not such computer or processor is explicitly shown.

Some embodiments in accordance with the present teachings provide improved gas leak-detection systems and methods based on Tunable Diode Laser Absorption Spectroscopy (TDLAS) techniques. For context, a discussion of conventional TDLAS technology is presented before disclosing the improved systems and methods in accordance with the present teachings.

Basic TDLAS operation . FIG. 1 depicts flow diagram 100 illustrating conventional TDLAS processing, such as may be used in conjunction with embodiments of the present invention.

In step S101, a narrow-linewidth tunable diode laser is tuned so that its optical frequency is near to the frequency of the absorption line of a gas of interest. The laser is modulated to create a controlled scan across the absorption line, which enables extraction of absorption information with high sensitivity. Two simultaneous modulations are typically used: a slow wavelength scan and a high-frequency sinusoidal modulation. The improves the sensitivity and noise rejection.

If the gas of interest is present in a region through which the laser light passes, photons from the laser light are absorbed by the gas (when the frequency of the modulated laser light matches a specific molecular transition of the gas). The greater the gas concentration, the greater the absorption of photons (other parameters being equal). Because absorption of photons is nonlinear in wavelength, harmonics of the modulation frequency are generated. It is notable that the absorption of such modulated laser light converts wavelength modulation into intensity modulation.

At step S102, the laser light that has passed through the gas is detected at a photodetector, which converts the optical power of the received laser-light signal to current. A transimpedance amplifier converts the current to voltage. The detected signal contains a DC component, the fundamental modulation frequency (1f), harmonics (2f, 3f, etc.), and noise.

At step S103, the signal is sent to a lock-in amplifier. The lock-in amplifier typically extracts the 2f signal (the second harmonic). Although both the 1f and 2f signals contain absorption information, 2f-signal detection is preferred for sensitivity, stability, and baseline robustness. Low-pass filtering extracts the amplitude of the 2f signal.

At step S104, conventional signal processing determines the gas concentration from the extracted amplitude. This is typically performed by a model-based fitting (e.g., performing a non-linear least-squares fit against a modeled Voigt line shape, etc.).

Having presented a brief overview of basic TDLAS processing, embodiments in accordance with the present teachings are now presented.

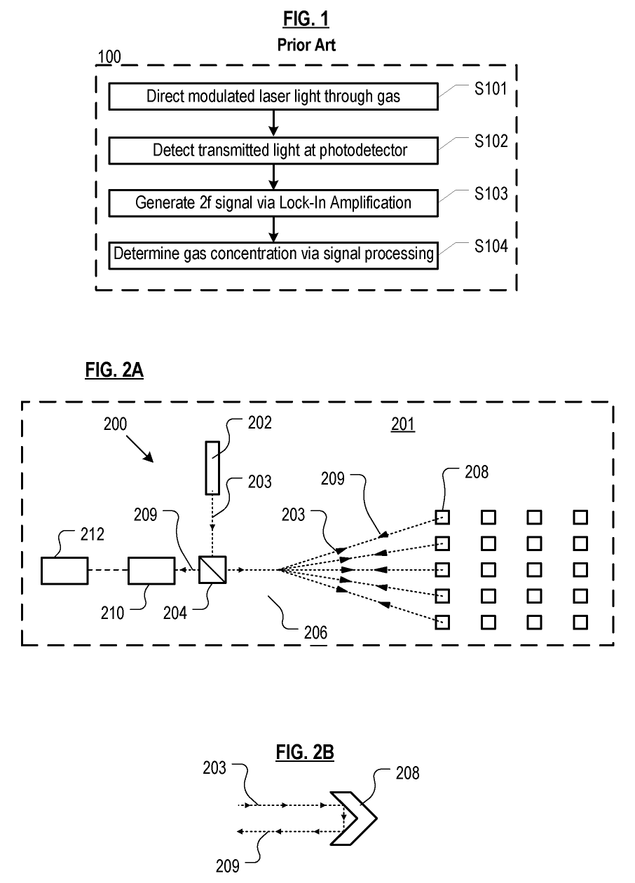

FIG. 2A depicts gas leak-detection system 200 in accordance with the illustrative embodiment. In the illustrative embodiment, leak-detection system 200 is deployed in gas-processing facility 201. Leak-detection system 200 includes laser 202, beam splitter 204, beam scanner 206, retroreflectors 208, detector 210, and signal-processing electronics 212.

In the embodiment depicted in FIG. 2A, laser 202, beam splitter 204, beam scanner 206, detector 210, and signal-processing electronics 212 are co-located, whereas retroreflectors 208 are positioned at various locations throughout gas-processing facility 201. In some other embodiments, signal-processing electronics 212 is located remotely from the laser/beam scanner/detector. Typical of such other embodimentsare those in which there are multiple instances of lasers/beam splitters/detectors located throughout a monitored region. (See, e.g., FIG. 7 and the accompanying discussion.)

In FIG. 2A, retroreflectors 208 are depicted as being arranged in a regular array. This is merely for clarity of illustration; in a typical installation, the prevailing placement considerations will result in retroreflectors 208 being sited at a variety of locations that do not result in a regular arrangement (arrayed or otherwise). For example, as a basic consideration, retroreflectors 208 will be positioned near to locations at which leaks most commonly occur. In a facility that processes gas (e.g., natural gas processing facility, a refinery, a hydrogen production facility, etc.), such locations include, without limitation, flanged connections, valves, fittings, pressure-relief devices, pumps and compressors, and welded joints. And to the extent that conditions such as vibration, thermal cycling, high pressure, or the presence of corrosive gas are present at a location, that increases the likelihood of leaks. A further important placement consideration is that there must be line-of-sight between the laser/beam scanner/detector and each retroreflector 208.

Leak-detection system 200 measures gas presence and concentration, using TDLAS techniques, along the line-of-sight between laser 202/detector 210 and each of retroreflectors 208. This results in a number of advantages in comparison to the prior art.

In particular, whereas some prior-art laser-based gas-detection systems rely on various relatively low-reflectivity surfaces to return the optical signal to the laser/detector, embodiments of the invention use retroflectors, which are highly reflective. Consequently, the significant scattering and absorption losses suffered by many prior-art systems are largely avoided in embodiments of the invention. This provides embodiments of the invention with significantly higher sensitivity than prior-art systems. Moreover, the high reflectivity of retroreflectors 208 enables relatively long beam paths (between laser/detector and retroreflector) while maintaining high sensitivity.

Notably, conventional laser-based, gas-detection systems have difficulty pinpointing the location of a gas leak, since a single laser-detector pair only covers one line-of-sight. However, in embodiments in accordance with the present teachings, wherein retroreflectors are distributed throughout a region, gas presence and concentration is detected along multiple optical paths (and, hence, at multiple locations) between the plural retroreflectors and a single laser source/detector. Using such data, leak-detection systems in accordance with the present teachings are able to accurately determine the origin of a leak.

Returning to the description of leak-detection system 200, laser 202 may be embodied as any of a variety of lasers that have a narrow linewidth and are tunable over a wavelength range of interest, which is the wavelength range of the absorption spectrum of one or more gases of interest. In the illustrative embodiment, the laser is a Distributed Feedback (DFB) laser having a narrow linewidth, which can be tuned to a specific frequency that is near to the (primary) absorption line of a gas of interest, such as methane, and that can be modulated to create a controlled scan across the frequency of the absorption line. Other types of lasers that are suitable for use in conjunction with embodiments of the invention include, without limitation, a Distributed Bragg Reflector (DBR) lasers, External Cavity Diode (ECD) lasers, and certain fiber lasers. Relative to other lasers, DFB and DBR lasers are relatively lower cost and complexity, and are therefore preferred for use.

Beam splitter 204 directs substantially all light it receives from laser 202 toward beam scanner 206, and directs substantially all light it receives from retroreflectors 208 to detector 210.

Beam scanner 206 is capable of steering light in multiple directions in a controlled manner; in this application, it steers laser light 203 to plural retroreflectors 208, one retroreflector at a time. In the illustrative embodiment, beam scanner 206 is a galvanometer (galvo) scanner, in which a small mirror is rotated rapidly and with high precision to direct outgoing optical beam 203 to each retroreflector 208. In system 200, beam scanner 206 also receives returning optical signal 209. Other types of beam scanners, such as polygon scanners or MEMS mirror scanners may suitably be used.

Retroreflectors 208 are optical devices that return incoming light back toward its source, largely independent of the angle of incidence of the light. Retroflectors may be of any suitable type, including, without limitation, corner-cube retroreflectors, cat’s-eye retroflectors, ball-lens retroreflectors, or micro-prismatic retroreflectors. FIG. 2B depicts further detail of a corner-cube retroflector, showing received optical beam 203 and return optical signal 209, wherein by operation of retroreflector 208, optical signal 209 is returned in the exact reverse travel direction of beam 203, although slightly offset.

Detector 210 is a photodetector, which converts the power of the received optical signal to a current. Typically, a transimpedance amplifier is used to convert the current to a voltage for further processing.

Signal-processing electronics 212 includes electronics suitable for processing signals generated by photodetector 210. Such electronics include, among any other electronics, a lock-in amplifier, low-pass filters, a processor running software that is capable of computing the concentration of the detected gas and estimating the location of a leak, and processor-accessible memory.

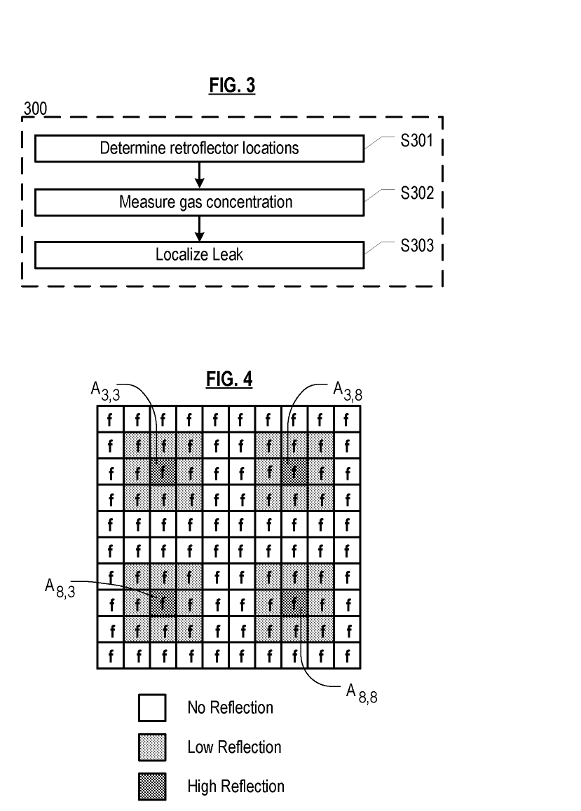

FIG. 3 depicts method 300 for gas measurement and leak localization in accordance with an illustrative embodiment of the present invention. In step S301, leak-detection system 200 determines the location of retroreflectors 208, which have been placed throughout a facility/region being monitored. Placement considerations for retroflectors 208 have been previously described.

In the illustrative embodiment, step S301 is performed by scanning surfaces of the facility at the modulation frequency (f) to identify the highest reflectivity areas, which are considered to correspond to the center of each retroreflector 208. This is accomplished using beam scanner 206, wherein beam 203 from laser 202 is directed to various locations. In the illustrative embodiment in which beam scanner 206 is a galvanometer, this is implemented by repeatedly altering the position of the galvanometer’s mirror(s). Detector 210 collects reflected beam intensity as various surfaces are scanned. The beam intensity and mirror position for each scanned position are stored in processor-accessible memory. This information may be used to generate an intensity map at modulation frequency f. Such a map is depicted in FIG. 4.

In the intensity map of FIG. 4, the highest-intensity regions correspond to the region at the center of retroreflectors 208. Relatively lower-intensity regions correspond to lower reflectance areas at the edge of retroreflectors 208. Other areas represent regions with no significant amount of reflection; that is, locations at which retroreflectors 208 are not present. Signal processing identifies the locations of highest intensity, which is considered by the system to be the precise locations of retroreflectors 208. In FIG. 4, the highest intensity regions are located at pixels A 3,3, A 3,8, A 8,3, and A 8,8_{.} It will be appreciated that the map depicted in FIG. 4 is presented for pedagogical purposes; system 200 does not necessarily create such a map as a step in determining the location of retroreflectors 208.

In some embodiments, a threshold intensity level may be considered in identifying a region as being the site of a retroflector. For example, rather simply identifying regions that show a maxima in intensity relative to surrounding regions as a site of a retroflector, such a site must additionally exhibit a threshold intensity. The threshold may be defined, for example, as a fraction of the intensity of the outgoing beam, etc.

In some embodiments, a look-up table, etc., is created that includes, among any other information, information that identifies each retroreflector (e.g., an alphanumeric identifier, its physical location on a particular piece of equipment, etc.) and information that enables beam scanner 206 to direct beam 203 to each such retroreflector 208. In embodiments in which beam scanner 206 is a galvanometer, a particular mirror angle is required to direct beam 203 to any particular retroreflector 208. As such, the stored information may include, for example, the voltage required to obtain a desired mirror angle of the galvanometer.

It is noted that step S301 is a calibration step; it will not be routinely performed during regular gas-monitoring operations. However, the calibration step should be performed periodically to account for any movement in the position of the retroreflectors, such as may occur to due vibrations at mounting locations, etc. Also, if one or more retroreflectors are moved, or added to the system, additional calibration is required.

After the locations of retroreflectors 208 are determined, gas concentration throughout the facility (i.e., in the path between the laser/detector and each retroreflector) is measured per step S302 of method 300. In the illustrative embodiment, this is performed using conventional TDLAS processing operations, per FIG. 1 and the accompanying description. However, unlike conventional laser-based gas-detection systems, the beam from laser 202 is precisely directed to locations of the various retroreflectors 208.

In some embodiments, leak-detection system 200 processes the second harmonic (2f) signal, for the reasons previously discussed (and as is well known in the art). And as a consequence of the focus only on high-reflection points throughout the facility (i.e., retroreflectors 208), return signal 209 experiences minimal losses, and processing proceeds more quickly than would otherwise be the case.

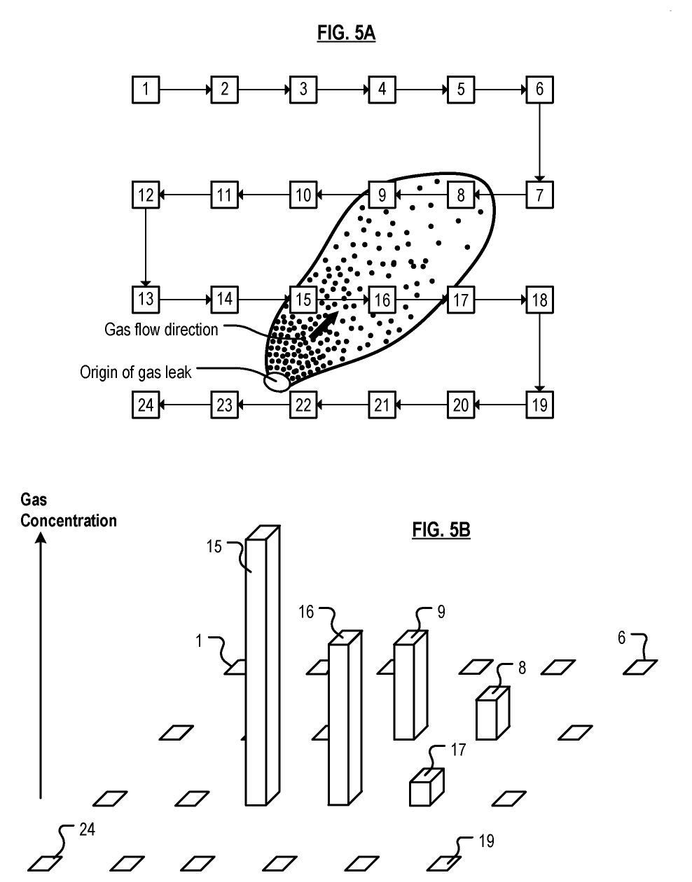

FIG. 5A depicts an illustrative gas-measurement sequence, in a scenario in which there is a gas leak near retroflector 15.

In FIG. 5A, scanning proceeds sequentially across all retroreflectors, which are numbered “1” through “24”. Gas concentration is obtained and recorded for each retroreflector. FIG. 5B is a histogram showing relative gas concentrations at the various retroreflector positions. The histogram reveals that the highest concentration of gas is detected in the path to retroreflector 15, indicating there is a possible gas leak near this retroreflector. The histogram is for pedagogical purposes; system 200 does not necessarily create such a histogram. Rather, the signal processing system determines the location of the peak gas concentration.

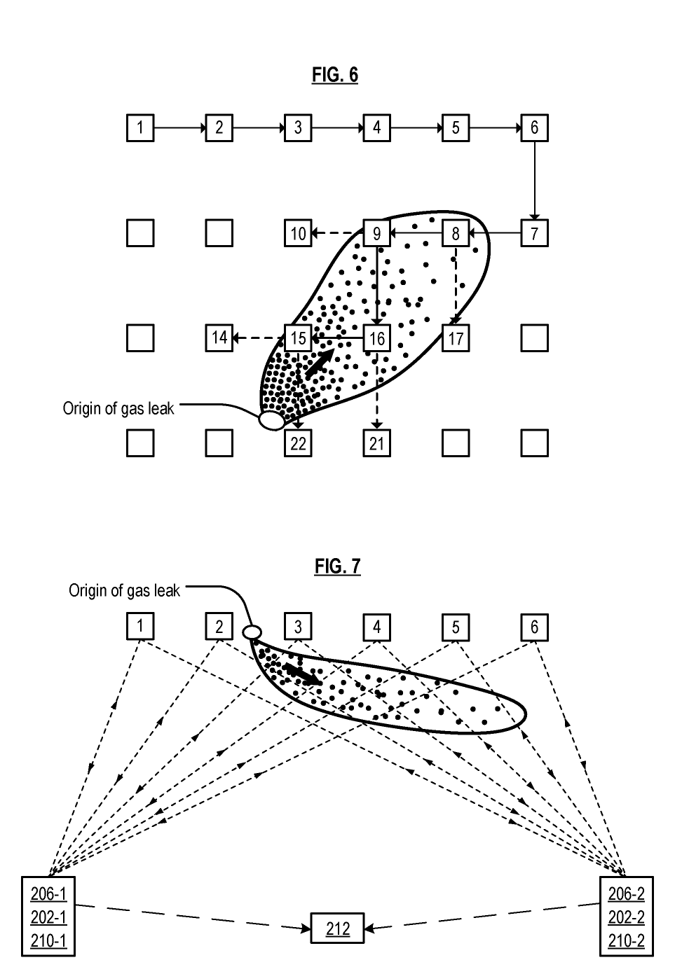

In some embodiments, rather than sequentially scanning all retroreflectors for leak detection and localization, an adaptive-scanning approach is used. Such an approach results in faster leak localization. An example of adaptive scanning is depicted in FIG. 6.

As shown in FIG. 6, adaptive scanning begins with sequential scanning. In this example, analysis identifies the first instance of the presence of gas at retroreflector 8. At this point, the system switches to an adaptive-scanning mode. In particular, system 200 immediately checks adjacent retroreflectors 9 and 17 to analyze gas concentration gradients. In this case, the retroreflector 9 shows a higher intensity than retroreflector 8, and retroreflector 17 shows a lower intensity than retroreflector 8. In such a situation, processing continues by proceeding in the direction of higher concentration (i.e., retroreflector 9).

The system then checks the retroreflectors adjacent to retroreflector 9, which are retroreflectors 10 and 16. In this example, retroreflector 16 shows a higher gas concentration than retroreflector 10. Consequently, system 200 proceeds by checking retroreflectors 15 and 21. If, as is the case in this example, retroreflector 15 shows a higher intensity retroreflector 21, system 200 continues by, once again, checking the adjacent positions; namely retroreflectors 14 and 22.

Since both retroreflectors 14 and 22 show lower concentrations than retroreflector 15, system 200 determines that the retroreflector 15 has the highest concentration. Therefore, the system concludes that the leak is in the vicinity of retroreflector 15. This is the same result as obtained by sequential scanning, as discussed in conjunction with FIG. 5A. But by using adaptive scanning, system 200 determined the highest concentration point after having taken sixteen measurements, rather than twenty-four measurements as for the sequential-scanning approach.

Both the sequential-scanning and adaptive-scanning techniques described above should be repeated multiple times to obtain time-averaged concentration data. This improves the accuracy of leak localization. In particular, the averaging process mitigates the effects of time-varying fume shapes, such as may be caused by wind or other conditions.

It is notable that system 200 may perform gas-leak detection without performing step S301 (determine retroflector location). That is, step S302 (measure gas concentration) may be performed without having to first determine the location of each retroflector 208. It will be appreciated, however, that this is a far less efficient implementation of the present teachings. As an alternative to proceeding without the precise location of retroreflectors 208 per step S301, processing could proceed with an approximate location of each retroflector. But once again, this is much less efficient than a method that includes calibration step S301.

In some further embodiments, multiple incidences of laser 202, beam scanner 206, and detector 210 are used in conjunction with the same group of retroreflectors 208. This improves location estimates of gas leaks. Such an embodiment is depicted in FIG. 7, wherein two groups of processing equipment (i.e., laser/beam scanner/detector) are used in conjunction with the same six retroreflectors 1 through 6.

As seen in FIG. 7, group-1 equipment (i.e., laser 202-1, beam scanner 206-1, and detector 210-1) detected gas along the path to/from retroreflectors 3, 4, 5, and 6. On the other hand, group-2 equipment (i.e., laser 202-2, beam scanner 206-2, and detector 210-2) detected gas along the path to/from retroreflectors 2, 3, 4, and 5. By analyzing gas-concentration measurement data from both (or either) group-1 or group-2 equipment, the direction of the gas flow can be determined. Measurements would show that the gas concentration, as measured in the paths to the retroreflectors on the left side of arrangement is greater than the gas concentration at the right side of arrangement of retroflectors. Consequently, the system determines that gas is flowing from left to right in scenario depicted in FIG. 7.

Since the gas flow direction is left to right, the origin of the leak, as estimated by group-1 equipment is more precise than that from group-2. The results from group-1 equipment indicate that the leak originates between retroreflectors 2 and 3, whereas group-2 equipment would indicate that the leak appears to be between retroreflectors 1 and 2.

Additionally, using two or more laser-detector setups allows for depth information of the gas plume to be obtained, further improving accuracy in leak detection.

What is claimed is:

1. A system for identifying a gas leak and estimating a location thereof in a monitored area, the system comprising:
a first narrow-wavelength tunable laser for producing a beam of light, wherein the first laser is tuned so that an optical frequency thereof is near to a frequency of an absorption line of a gas of interest, and is modulated to create a controlled scan across the frequency of the absorption line;
a first plurality of retroreflectors, wherein the retroreflectors are situated at various locations throughout the monitored area;
a first beam scanner, wherein there is line-of-sight between the first beam scanner and the first plurality of retroreflectors;
a first photodetector; and
signal-processing electronics; wherein:
(a) the first beam scanner receives and directs the beam of light from the first laser to at least some of the retroreflectors (“receiving retroreflectors”), one retroreflector at a time;
(b) receiving retroreflectors direct the beam of light to the first detector;
(c) the first photodetector generates signals that are indicative, respectively, of an intensity of the beam of light delivered from each receiving retroreflector; and
(d) the signal-processing electronics determines, for the receiving retroreflectors, a concentration of the gas of interest based on the intensity of the respective beams of light, and estimates a location of a gas leak based on the determined concentrations and locations in the monitored area of the receiving retroreflectors.

2. The system of claim 1 wherein the first beam scanner is a galvanometer.

3. The system of claim 1 wherein the beam scanner directs the beam of light to all photodetectors of the plurality thereof.

4. The system of claim 1 wherein the processor accesses information that enables the beam scanner to direct the beam of light to receiving retroreflectors.

5. The system of claim 4 wherein the beam scanner is galvanometer, and the information relates to a position of a mirror of the galvanometer.

6. The system of claim 1 wherein the first laser is a distributed feedback laser.

7. The system of claim 1 wherein the gas of interest is methane.

8. The system of claim 1 further comprising:
a second narrow-wavelength tunable laser for producing a beam of light, wherein the second laser is tuned so that an optical frequency thereof is near to the frequency of the absorption line of the gas of interest, and is modulated to create a controlled scan across the frequency of the absorption line;
a second beam scanner, wherein there is line-of-sight between the second beam scanner and the first plurality of retroreflectors; and
a second photodetector, wherein
the first narrow-wavelength tunable laser, the first beam scanner, and the first photodetector are co-located at a first location in monitored area, and the second narrow-wavelength tunable laser, the second beam scanner, and the second photodetector are co-located at a second location in monitored area, wherein the first location is different from the second location.

9. A method for identifying a gas leak and estimating a location thereof in a monitored area, the method comprising:
directing a beam of light from a first, narrow-wavelength tunable laser to plural retroreflectors, one reflector at a time, the retroreflectors being situated at various locations throughout the monitored area, wherein the beam of light:
(a) has an optical frequency near to a frequency of an absorption line of a gas of interest, and
(b) is modulated to create a controlled scan across the frequency of the absorption line;
receiving, at a first photodetector, respective beams of light returned from the plural retroreflectors;
generating, at the first photodetector, signals that are indicative of an intensity of the beams of light returned from respective plural retroreflectors;
determining, for each of the plural retroreflectors, a respective concentration of the gas of interest based on the intensity of beams of light returned from respective retroreflectors; and
estimating a first location of a gas leak based on the determined concentrations and locations in the monitored area of the plural retroreflectors.

10. The method of claim 9 comprising determining a direction of gas flow of the gas leak based on the determined concentrations of the gas of interest.

11. The method of claim 9 wherein the plural retroreflectors to which the beam of light is directed represents some, but not all of the retroreflectors situated throughout the monitored area.

12. The method of claim 11 comprising determining a location of all the retroreflectors in the monitored area.

13. The method of claim 12 wherein determining a location of all the retroflectors comprises:
directing, a beam of light to plural locations within the monitored area, one location at a time;
receiving, at the first photodetector, light reflected from each of the plural locations;
generating, at the first photodetector, a signal for the light received from each of the plural locations, the signal being indicative of the intensity of the received light;
identifying locations of the plurality thereof that exhibit a relative maxima in intensity or exceed a threshold intensity, and designating such locations as a location of a retroreflector.

14. The method of claim 12 comprising generating a look-up table that includes an identifier for all the retroreflectors in the monitored area and information that enables the beam of light to be directed to each of the retroreflectors.

15. The method of claim 9 wherein determining the concentration of the gas of interest comprises extracting a second harmonic of each signal generated by the first photodetector.

16. The method of claim 10 comprising:
directing a beam of light from a second, narrow-wavelength tunable laser to the plural retroreflectors, wherein the beam of light from the second laser has the same optical frequency as the first laser, and wherein the second laser is at a different location than the first laser;
receiving, at a second photodetector, beams of light returned from the plural retroreflectors, wherein the second photodetector is at a different location that the first photodetector;
generating, at the second detector, signals that are indicative, respectively, of an intensity of the beams of light returned from the plural photodetectors;
determining, for each of the plural retroreflectors, a respective concentration of the gas of interest based on the intensity of beams of light returned from respective retroreflectors;
estimating a second location of a gas leak based on the determined concentrations and locations in the monitored area of the plural retroreflectors; and
selecting one of the first location and the second location as the relatively more likely location of the gas leak based on the direction in which the gas flows from the gas leak.

17. A system for identifying a gas leak and estimating a location thereof in a monitored area, the system comprising:
a narrow-wavelength tunable laser for producing a beam of light;
a plurality of retroreflectors, wherein the retroreflectors are situated at various locations throughout the monitored area;
a beam scanner, wherein there is line-of-sight between the beam scanner and the plurality of retroreflectors so that the retroreflectors receive the beam of light from the laser;
a photodetector for receiving respective return beams from the retroflectors, and generating respective signals indicative of an intensity of the return beams; and
signal-processing electronics for estimating a location of a gas leak based on the signals.
